(19) United States
(12) Patent Application Publication
(10) Pub. No.: US 2020/0042883 A1
(43) Pub. Date: Feb. 6, 2020

(54) DICTIONARY LEARNING DEVICE, DICTIONARY LEARNING METHOD, DATA RECOGNITION METHOD, AND PROGRAM STORAGE MEDIUM

(71) Applicant: NEC Corporation, Minato-ku, Tokyo (JP)

(72) Inventor: Atsushi SATO, Tokyo (JP)

(73) Assignee: NEC Corporation, Minato-ku, Tokyo (JP)

(21) Appl. No.: 16/467,576

(22) PCT Filed: Dec. 13, 2017
(86) PCT No.: PCT/JP2017/044650

§ 371 Date: Jun. 7, 2019

(30) Foreign Application Priority Data
Dec. 21, 2016 (JP) 2016-247431

(51) Int. Cl. G06N 5/04; G06N 20/00

(52) U.S. Cl. CPC G06N 5/04; G06N 20/00

(57) ABSTRACT

A dictionary learning device includes a calculation unit and a selection unit. Based on the feature vectors, multiple of teaching data are arranged in a feature space having, as variables, elements that constitute a feature vector in the teaching data. For each unlabeled data included in the multiple of teaching data the calculation unit calculates the importance of the unlabeled data based on the density of labeled data in the teaching data in a region having a size that has been set using that unlabeled data as a standard. Based on the information representing the closeness of an unlabeled data and a discrimination boundary based on a discrimination function serving as a basis for discriminating data, and information representing the importance from the calculation unit, the selection unit selects data to be labeled from among the multiple of unlabeled data.

### TECHNICAL FIELD

The present invention relates to a technique of active learning which is one type of machine learning.

### BACKGROUND ART

A discriminator to be used for causing a computer to recognize (discriminate) a pattern of a speech, an image, or the like learns by machine learning. As one type of machine learning, there is supervised learning. In the supervised learning, data (training data) given a label being information indicating a correct discrimination answer are used for learning a parameter of a discrimination function called a dictionary that serves as a basis for discrimination.

In supervised learning, an operation of labeling data is required. While it is desirable that a large amount of training data are used in learning in order to increase accuracy of discrimination by the discriminator, it is too time-consuming and labor-consuming to perform an operation of labeling all of the data when an amount of data to be labeled increases. Active learning is machine learning that takes into consideration such circumstances. In active learning, data to be labeled are selected rather than labeling all data, thereby attempting to improve efficiency of the learning.

PTL 1 discloses a technique in which unlabeled images being widely different in feature from labeled images already given labels and unlabeled images being close to a determination plane are selected as image data to be labeled. NPL 1 also describes a configuration in which data that are likely to be given incorrect labels are selected, and the selected data are labeled.

### CITATION LIST

### Patent Literature

[PTL 1] Japanese Unexamined Patent Application Publication No. 2013-125322

### Non Patent Literature

[NPL1] B. Settles, Active Learning Book, Synthesis Lectures on Artificial Intelligence and Machine Learning, Morgan & Claypool Publishers, June 2012

### SUMMARY OF INVENTION

### Technical Problem

While various methods for selecting data to be labeled in active learning have been proposed, there is a demand for a method that enables learning to be advanced more efficiently.

The present invention has been made in order to solve such a problem. Specifically, a primary object of the present invention is to provide a technique that enables machine learning to be performed more efficiently.

### Solution to Problem

To achieve the object, a dictionary learning device of the present invention, as an aspect, includes:

an importance calculation unit that calculates an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size; and

a data selection unit that selects data to be labeled from among the plurality of pieces of unlabeled data using information on closeness of the piece of unlabeled data to a discrimination boundary and information on the calculated importance, the discrimination boundary being based on a discrimination function to serve as a basis for discriminating data.

A dictionary learning method of the present invention, as an aspect, includes:

calculating an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size;

selecting data to be labeled from among the plurality of pieces of unlabeled data using information on closeness of the piece of unlabeled data to a discrimination boundary and information on the calculated importance, the discrimination boundary being based on a discrimination function to serve as a basis for discriminating data;

when information on a label with which the selected piece of unlabeled data is to be labeled is received from outside, giving the selected piece of unlabeled data with the label; and

improving the discrimination function by learning a dictionary using a plurality of pieces of the training data, the plurality of pieces of the training data including new piece of labeled data given the label, the dictionary being a parameter of the discrimination function.

A data recognition method of the present invention, as an aspect, includes:

calculating an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size;

selecting data to be labeled from among the plurality of pieces of unlabeled data using information on closeness of the piece of unlabeled data to a discrimination boundary and information on the calculated importance, the discrimination boundary being based on a discrimination function to serve as a basis for discriminating data;

when information on a label with which the selected piece of unlabeled data is to be labeled is received from outside, giving the selected piece of unlabeled data with the label;

learning the discrimination function by learning a dictionary using a plurality of pieces of the training data, the plurality of pieces of the training data including new piece of labeled data given the label, the dictionary being a parameter of the discrimination function; and

recognizing data received from outside using the learned discrimination function.

A program storage medium of the present invention on which a computer program is stored, as an aspect, the computer program causing a computer to perform:

calculating an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size;

selecting data to be labeled from among the plurality of pieces of unlabeled data using information on closeness of the piece of unlabeled data to a discrimination boundary and information on the calculated importance, the discrimination boundary being based on a discrimination function to serve as a basis for discriminating data.

Note that the above-described primary object of the present invention is also achieved by a dictionary learning method associated with the dictionary learning device according to the present invention. Further, the above-described primary object of the present invention is also achieved by a computer program associated with the dictionary learning device and the dictionary learning method according to the present invention, and a storage medium on which the computer program is stored.

### Advantageous Effects of Invention

The present invention enables machine learning to be performed more efficiently.

### BRIEF DESCRIPTION OF DRAWINGS

FIG. 1 is a block diagram representing a simplified configuration of a dictionary learning device according to a first example embodiment of the present invention.

FIG. 2 is a diagram explaining technical matters in the dictionary learning device according to the first example embodiment.

FIG. 3 is a diagram explaining technical matters in the dictionary learning device according to the first example embodiment succeeding to FIG. 2.

FIG. 4 is a diagram explaining technical matters in the dictionary learning device according to the first example embodiment succeeding to FIG. 3.

FIG. 5 is a diagram explaining technical matters in the dictionary learning device according to the first example embodiment succeeding to FIG. 4.

FIG. 6 is a diagram explaining technical matters in the dictionary learning device according to the first example embodiment succeeding to FIG. 5.

FIG. 7 is a block diagram representing a simplified configuration of a pattern recognition device that uses a discrimination function (dictionary) learned by the dictionary learning device according to the first example embodiment.

FIG. 8 is a block diagram representing a simplified configuration of each of dictionary learning devices according to second to fourth example embodiments of the present invention.

FIG. 9 is a block diagram representing a simplified hardware configuration of each of the dictionary learning devices according to the second to fourth example embodiments.

FIG. 10 is a flowchart explaining an example of a learning operation in the dictionary learning device according to the second example embodiment.

### EXAMPLE EMBODIMENT

Example embodiments according to the present invention will be described below, based on the drawings.

### First Example Embodiment

A dictionary learning device according to a first example embodiment of the present invention is a device that learns a dictionary by supervised learning which is one type of machine learning. A dictionary here is a parameter of a discrimination function that serves as a basis for discriminating or identifying (recognizing) data.

The dictionary learning device according to the first example embodiment has a configuration based on technical matters described below. FIG. 2 illustrates an example in which a plurality of pieces of training data are arranged in a feature space that has elements X and Y constituting a two-dimensional feature vector of the training data as variables based on the feature vector. Black circles in FIG. 2 represent training data given a label of class A (in other words, labeled data). Squares represent training data given a label of class B (in other words, labeled data). Triangles represent training data not given labels (in other words, unlabeled data).

Here, a discrimination function that servers as a basis for discriminating class A is defined as being the same as a discrimination function that serves as a basis for discriminating class B. Accordingly, a discrimination boundary between class A and class B based on the discrimination function is represented by a dashed line F in FIG. 2.

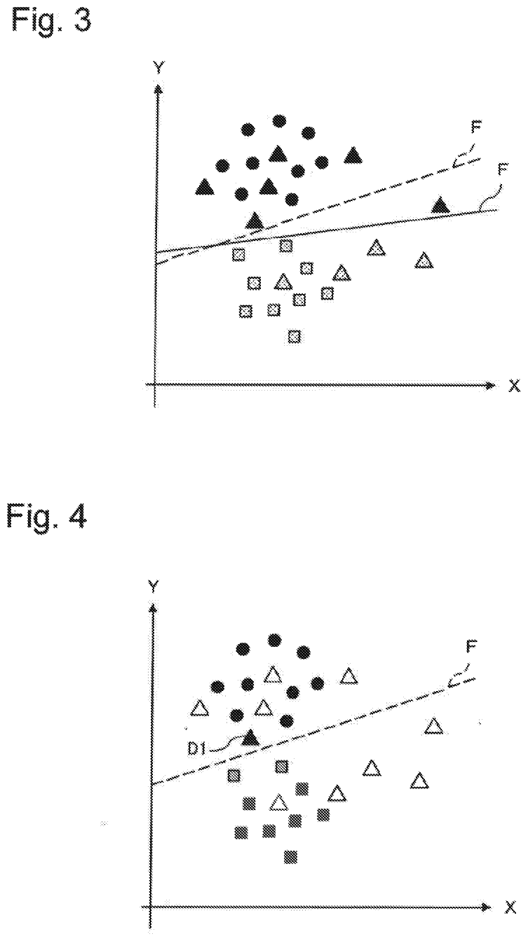

For example, it is assumed that all of the unlabeled data (Δ) in FIG. 2 have been labeled and a result as illustrated in FIG. 3 has been obtained. In FIG. 3, data newly given the label of class A are represented by black triangles and data newly given the label of class B are represented by gray triangles. By machine learning based on labeled data to which new data labeled as described above are added, the discrimination boundary based on the learned discrimination function is improved from the discrimination boundary F represented by the dashed line F in FIG. 3 to a discrimination boundary F represented by a solid line, for example.

In order to reduce the labor (in other words, to increase efficiency) of labeling training data, it may be envisaged to label data selected from among pieces of unlabeled data, rather than label all the pieces of unlabeled data. However, in this case, a problem rises that an accurate discrimination function cannot be obtained unless data to be labeled are properly selected. For example, it is assumed that a piece of data D1 illustrated in FIG. 4 is selected from among pieces of unlabeled data (Δ) illustrated in FIG. 2 and is given the label of class A. In this case, the discrimination boundary F of the discrimination function shows little change even when machine learning is performed based on the labeled data including the newly labeled piece of data D1. In other words, when all the pieces of unlabeled data (Δ) are labeled and machine learning is performed based on the labeled data including the labeled piece of data, the discrimination boundary F of the discrimination function represented by the solid line in FIG. 3 can be obtained. While obtaining such the discrimination boundary F is desirable, the discrimination boundary F represented by the solid line cannot be obtained in machine learning that takes into consideration the piece of data D1 selected and labeled as described above.

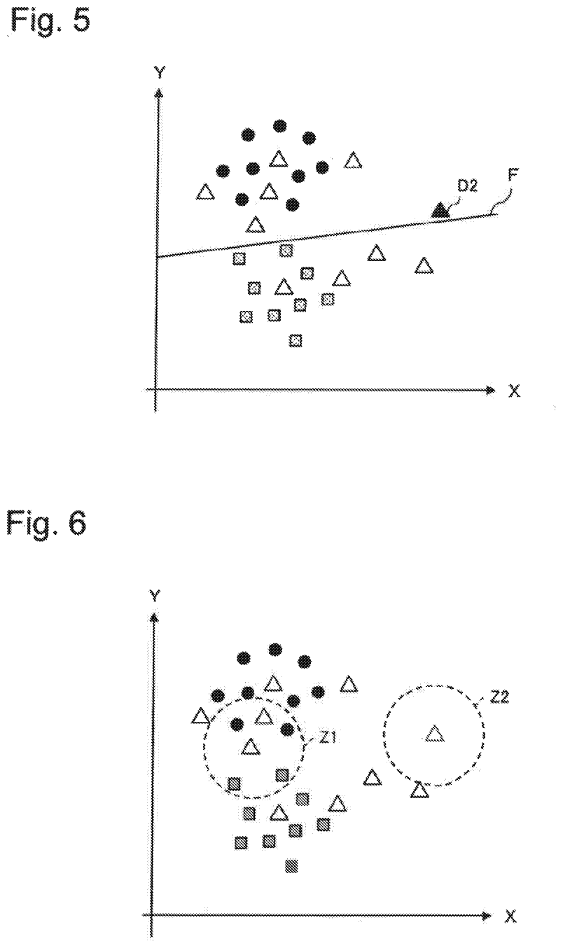

On the other hand, it is assumed for example that a piece of data D2 illustrated in FIG. 5 is selected from among the pieces of unlabeled data (Δ) illustrated in FIG. 2 and is given the label of class A. In this case, when machine learning is performed based on the labeled data including the newly labeled piece of data D2, the discrimination boundary F that is nearly identical to the discrimination boundary F of the discrimination function represented by the solid line in FIG. 3 can be obtained. In other words, in spite of the fact that not all of the unlabeled data have been labeled, a discrimination function (dictionary) with a high level of accuracy similar to the accuracy that can be achieved when learning is performed by labeling all of the unlabeled data can be obtained by selecting and labeling the piece of data D2.

The present inventor therefore has studied conditions for selecting unlabeled data with which a discrimination function (dictionary) can be learned efficiently and accurately and has found that it is preferable to select unlabeled data that are close to the discrimination boundary F and have a low density of labeled data.

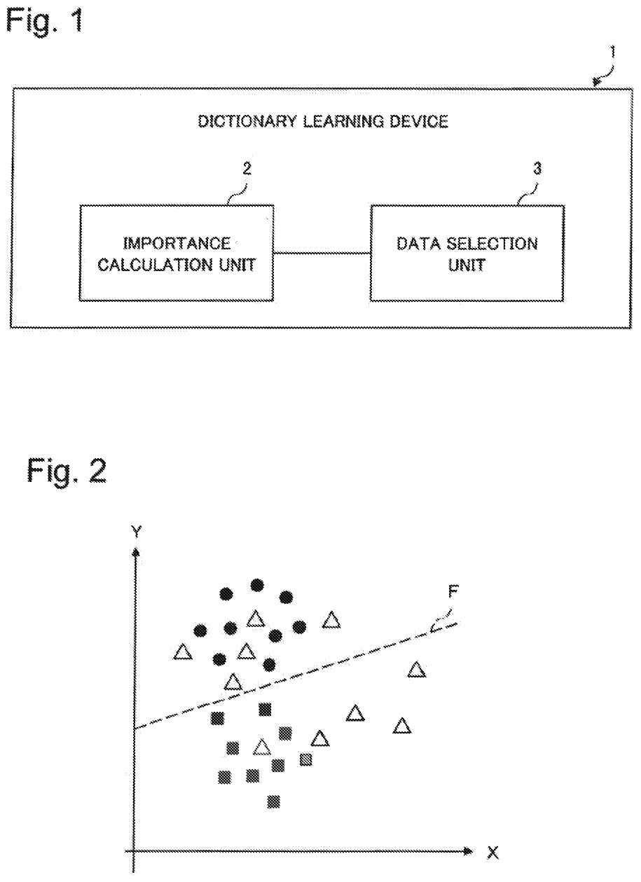

Therefore, the dictionary learning device according to the first example embodiment has the following configuration. FIG. 1 is a block diagram representing a simplified configuration of the dictionary learning device according to the first example embodiment. The dictionary learning device 1 according to the first example embodiment includes an importance calculation unit 2 and a data selection unit 3.

The importance calculation unit 2 includes a function of calculating an importance of each piece of unlabeled data included in training data as follows. A plurality of pieces of training data are arranged in a feature space at positions based on each feature vector of the plurality of pieces of training data. Here, the feature space is a space that has elements constituting the feature vector of the training data as variables. In this case, for each piece of unlabeled data included in the plurality of pieces of training data, the importance calculation unit 2 obtains a density of labeled data in a region (for example, regions Z1, Z2 depicted in FIG. 6). The region has a predetermined size and is a region where the unlabeled data as a reference is arranged. Based on the obtained density, the importance calculation unit 2 calculates the importance of the unlabeled data using a predetermined calculation method.

The data selection unit 3 includes a function of selecting data to be labeled from among a plurality of pieces of unlabeled data using information on the calculated importance and information on closeness of the unlabeled data to a discrimination boundary. The discrimination boundary is based on a discrimination function that serves as a basis for discriminating data.

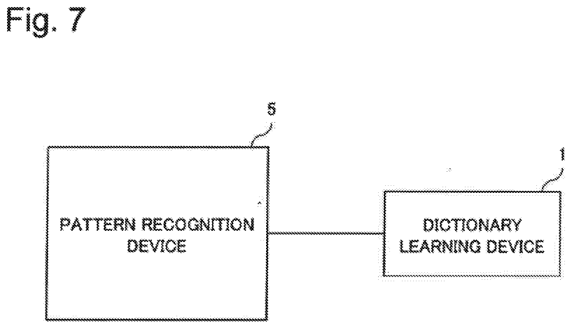

The dictionary learning device 1 according to the first example embodiment further includes a function of, when the selected unlabeled data are given labels, learning the discrimination function (dictionary) using the training data including the unlabeled data, for example. The discrimination function (dictionary) thus learned is output from the dictionary learning device 1 to a pattern recognition device 5 depicted in FIG. 7, for example, and is used for pattern recognition processing by the pattern recognition device 5.

The dictionary learning device 1 according to the first example embodiment which has the configuration as described above is capable of learning a dictionary efficiently and accurately by labeling the unlabeled data selected by the data selection unit 3 without having to label all unlabeled data.

Note that functional units of the importance calculation unit 2 and the data selection unit 3 are implemented by a computer executing a computer program to implement such functions, for example.

### Second Example Embodiment

A second example embodiment of the present invention will be described below.

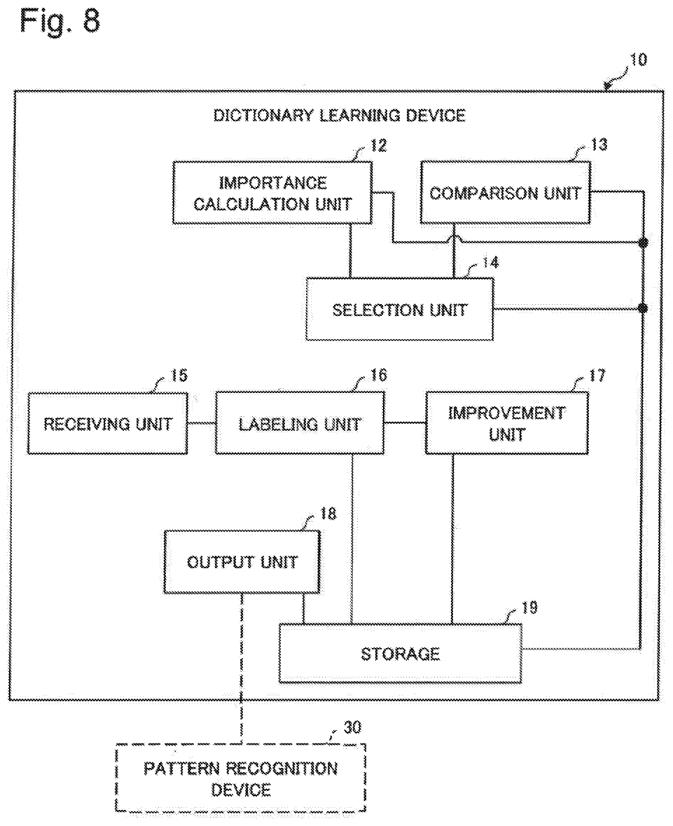

FIG. 8 is a block diagram representing a simplified functional configuration of a dictionary learning device according to the second example embodiment. A dictionary learning device 10 according to the second example embodiment includes an importance calculation unit 12, a comparison unit 13, a selection unit (data selection unit) 14, a receiving unit 15, a labeling unit 16, an improvement unit 17, an output unit 18 and a storage 19.

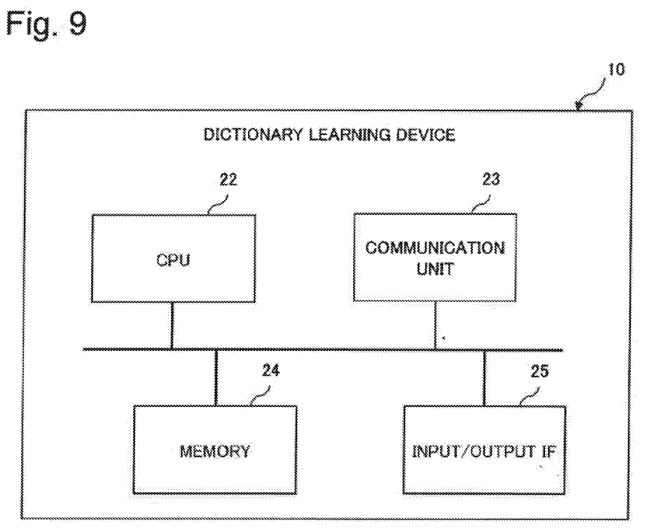

Note that FIG. 9 is a block diagram representing a simplified hardware configuration of the dictionary learning device 10. The dictionary learning device 10 includes, for example, a Central Processing Unit (CPU) 22, a communication unit 23, a memory 24, and an input/output interface (IF) 25. The communication unit 23 includes, for example, a function of connecting to other devices (not depicted) and the like through an information communication network (not depicted), and providing communication with the devices and the like. The input/output IF 25 includes a function of connecting a display device (not depicted) and an input device (not depicted) such as a keyboard through which an operator (a user) of the device inputs information, and providing communication of information (signals) with these devices. The receiving unit 15 and the output unit 18 may be implemented by the input/output IF 25, for example.

The memory 24 is a storage that stores data and a computer program (program). Although there are a wide variety of storages and a plurality of types of storages may be provided in a single device, storages are collectively represented as one memory herein. The storage 19 is implemented by the memory 24.

The CPU 22 is an operational circuit and includes a function of controlling operations of the dictionary learning device 10 by reading and executing a program stored in the memory 24. For example, the importance calculation unit 12, the comparison unit 13, the selection unit 14, the labeling unit 16, and the improvement unit 17 are implemented by the CPU 22.

In the second example embodiment, training data and a discrimination function (dictionary) are stored in the storage 19. The discrimination function is a function used in processing for discriminating (recognizing) data of a pattern of an image, speech or the like, for example, by a computer. Specifically, a plurality of classes for classifying patterns are set in advance and the discrimination function is used in processing by the computer for discriminating and classifying data to be classified into classes.

The training data is data used in processing for learning a parameter (also referred to as a dictionary) of the discrimination function. The training data include types of labeled data and unlabeled data. The labeled data is given label that represents information of classes into which the data are classified. The unlabeled data is not given the label. It is assumed here that the training data of both a plurality of pieces of labeled data and a plurality of pieces of unlabeled data are stored in the storage 19.

The dictionary learning device 10 according to the second example embodiment includes a function of using a plurality of pieces of training data stored in the storage 19 and learning the discrimination function (in other words, the dictionary) by means of the importance calculation unit 12, the comparison unit 13, the selection unit 14, the receiving unit 15, the labeling unit 16 and the improvement unit 17.

Specifically, the importance calculation unit 12 includes a function of calculating an importance (a weight) of each of the plurality of pieces of unlabeled data stored in the storage 19. The importance is a value calculated, for each piece of unlabeled data, using a density of labeled data in a region where the piece of unlabeled data as a reference is arranged and has a predetermined size.

Here, a specific example of a method for calculating the importance will be described. For example, it is assumed that a plurality of pieces of training data in the storage 19 are arranged in a feature space using a feature vector of training data. Here, the feature space is a space that has elements constituting the feature vector of training data as variables. In this case, the importance calculation unit 12 obtains, for each piece of unlabeled data of the training data, the density of labeled data in a region where the piece of unlabeled data as a reference is arranged and has a predetermined size. For example, the density of labeled data in a region the piece of unlabeled data Dn as a reference is arranged and has a predetermined size is denoted by ρ_{L}(Dn), assuming that Dn is the piece of unlabeled data (where, n is an integer from 1 to the number of pieces of the unlabeled data).

The importance calculation unit 12 then calculates an importance W(Dn) of each piece of unlabeled data using the obtained density and Formula (1).

W(Dn)=a/(ρ_{L}(Dn)+a) (1)

where, “a” in Formula (1) represents a preset positive real number.

The importance W(Dn) calculated according to Formula (1) approaches “1” as the density ρ_{L}(Dn) of labeled data decreases, and approaches “0” as the density ρ_{L}(Dn) of labeled data increases.

The importance calculation unit 12 stores information on the calculated importance W(Dn) in the storage 19, for example.

The comparison unit 13 includes a function of obtaining closeness of each piece of unlabeled data to the discrimination boundary based on the discrimination function. For example, a likelihood function r(Dn; θ) for obtaining the closeness of unlabeled data Dn to the discrimination boundary based on the discrimination function is defined as Formula (2).

r(Dn;θ)=|g₁(Dn;θ)−g₂(Dn;θ) (2)

where, “g₁(Dn; θ)” in Formula (2) represents the discrimination function for discriminating preset class 1. “θ” represents a parameter (dictionary) of the discrimination function. “g₂(Dn; θ)” represents the discrimination function for discriminating preset class 2. “θ” represents the parameter (dictionary) of the discrimination function.

In the second example embodiment, when a value of g₁(Dn; θ) is equal to a value of g₂(Dn; θ), the likelihood function r(Dn; θ) becomes “0”, and therefore it is represented that the piece of unlabeled data Dn approaches the discrimination boundary as the value of the likelihood function r(Dn; θ) relating to the piece of unlabeled data Dn approaches “0”. In other words, the closer the likelihood function r(Dn; θ) is to “0”, the closer the piece of unlabeled data Dn is to the discrimination boundary and therefore the piece of unlabeled data Dn is determined to be data that is likely to be erroneously discriminated in discrimination processing.

The comparison unit 13 stores information on the calculated closeness to the discrimination boundary r(Dn; θ) in the storage 19, for example.

The selection unit 14 includes a function of selecting data to be used in learning a parameter (dictionary) of a discrimination function from among pieces of unlabeled data using the importance W(Dn) calculated by the importance calculation unit 12 and the closeness to the discrimination boundary r(Dn; θ) calculated by the comparison unit 13. For example, the selection unit 14 calculates, for each piece of unlabeled data, information J(Dn) representing a level of priority in selection using the importance W(Dn) calculated by the importance calculation unit 12 and the closeness to the discrimination boundary r(Dn; θ) calculated by the comparison unit 13. The information on the level of priority in selection (also simply referred to as a selection priority level) J(Dn) is calculated according to Formula (3), for example.

J(Dn)=W(Dn)^{γ}/(1+r(Dn;θ)) (3)

where, “γ” in Formula (3) represents a preset positive real number (for example, a positive real number set in accordance with a content to be learned).

The selection priority level J(Dn) represented by Formula (3) increases as the density of labeled data deceases and also increases as the discrimination boundary is approached. In other words, the selection priority level J(Dn) increases as the discrimination boundary is approached and the density of labeled data decreases.

The selection unit 14 selects data to be labeled from among pieces of unlabeled data, based on the calculated selection priority level J(Dn) of each piece of unlabeled data. In a method for selecting data, for example, the selection unit 14 selects a set number of pieces of data from among pieces of unlabeled data in descending order of selection priority levels J(Dn). Alternatively, the selection unit 14 may select the unlabeled data that has the selection priority level J(Dn) higher than or equal to a preset threshold. Further, the selection unit 14 may select the unlabeled data that has the highest selection priority level J(Dn). In this way, an appropriate method is adopted as a method for selecting a piece of data from among pieces of unlabeled data using the selection priority levels J(Dn).

Information of the data thus selected is stored in the storage 19 by the selection unit 14.

For example, it is assumed that a message or the like that prompts an operator (a user) of the dictionary learning device 10 to label data selected as a result of the processing described above is presented to the operator (user) and the operator (user) inputs information representing a label using an input device (not depicted).

The receiving unit 15 includes a function of receiving (accepting) information on the label input by the operator (user) as described above.

The labeling unit 16 includes a function of, when the label is input, reading the unlabeled data corresponding to the input label from the storage 19, and giving the unlabeled data with the input label, and updating the data as new labeled data in the storage 19.

The improvement unit 17 includes a function of, when there are data updated from the unlabeled data to the labeled data, learning the parameter (dictionary) of the discrimination function and updating the learned discrimination function (i.e., the dictionary) in the storage 19.

The output unit 18 includes a function of outputting the discrimination function (dictionary) stored in the storage 19. Specifically, for example, when the dictionary learning device 10 receives a request to output the discrimination function (dictionary) sent from the pattern recognition device 30 illustrated in FIG. 8 while the dictionary learning device 10 is connected to the pattern recognition device 30, the output unit 18 outputs the discrimination function (dictionary) to the pattern recognition device 30.

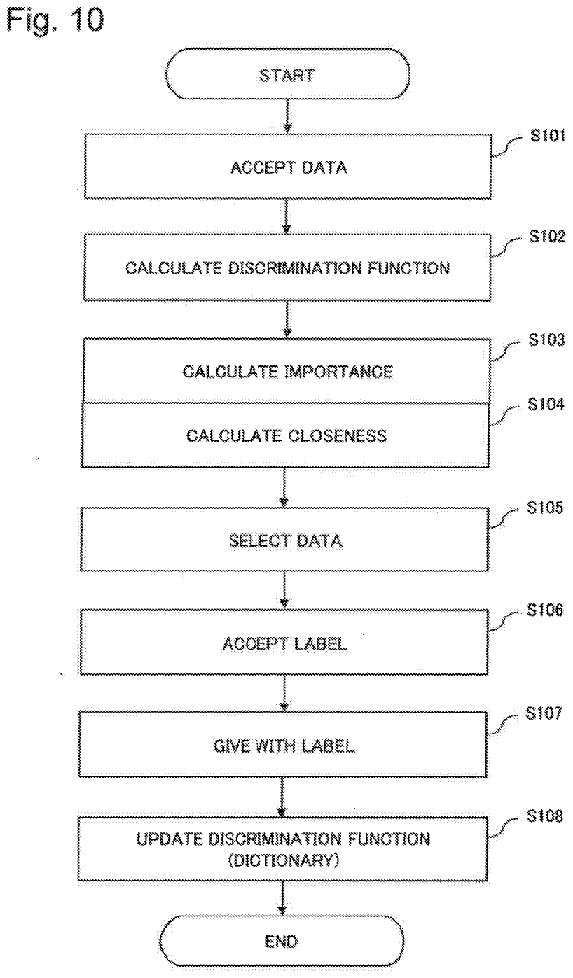

The dictionary learning device 10 according to the second example embodiment has the configuration described above. An example of an operation relating to dictionary learning processing in the dictionary learning device 10 will be described using a flowchart in FIG. 10.

For example, when the dictionary learning device 10 receives a plurality of pieces of training data that include the labeled data and the unlabeled data, the dictionary learning device 10 stores the pieces of training data into the storage 19 (step S101). The dictionary learning device 10 then learns the discrimination function using a preset machine learning method and the labeled data among the pieces of training data (step S102) and stores the discrimination function obtained through the learning in the storage 19.

Thereafter, the importance calculation unit 12 of the dictionary learning device 10 calculates the importance W(Dn) of each piece of the unlabeled data Dn in the storage 19 using the density of labeled data ρ_{L}(Dn) and Formula (1) described above, for example (step S103). Further, the comparison unit 13 calculates the closeness r(Dn; θ) of each piece of the unlabeled data to the discrimination boundary using the discrimination function stored in the storage 19 according to Formula (2) described above (step S104).

Then, the selection unit 14 calculates the selection priority level J(Dn) of each piece of the unlabeled data as described above using the importance W(Dn) calculated by the importance calculation unit 12 and the closeness r(Dn;θ) to the discrimination boundary calculated by the comparison unit 13. The selection unit 14 then selects the data to be labeled from among the pieces of unlabeled data Dn using the calculated selection priority levels J(Dn) (step S105).

Subsequently, when the receiving unit 15 accepts information on the label with which the selected data to be labeled are given (step S106), the labeling unit 16 gives the corresponding unlabeled data with the label (step S107). With this, the data given the label is updated as new labeled data in the storage 19.

Then, the improvement unit 17 learns the discrimination function (dictionary) using the labeled data including the new labeled data given the label, and updates the learned discrimination function (dictionary) in the storage 19 (step S108).

The dictionary learning device 10 thus learns the discrimination function (dictionary).

As described above, the dictionary learning device 10 according to the second example embodiment includes the function of selecting the unlabeled data that is in the region of low density of labeled data and is close to the discrimination boundary, and learns the discrimination function (dictionary) using the plurality of pieces of labeled data which include the selected data given a label. The dictionary learning device 10 thus can efficiently and accurately learn the discrimination function (dictionary) as in the first example embodiment.

An example has been described in which the training data including the labeled data and the unlabeled data are input in the step S101 of the flowchart illustrated in FIG. 10 in the second example embodiment. However, the training data that do not include the labeled data (training data constituted of the unlabeled data) may be input in the step S101. In this case, the discrimination function cannot be calculated using the input training data because the training data do not include the labeled data. In this case, therefore, information on the discrimination function is stored in the storage as initial data in advance and the operation of calculating the discrimination function in the step S102 is omitted.

### Third Example Embodiment

A third example embodiment of the present invention will be described below. Note that in the description of the third example embodiment, components with the same names as the names of the components constituting the dictionary learning device according to the second example embodiment are given the same reference symbols and repeated description of the common components will be omitted.

In a dictionary learning device 10 according to the third example embodiment, the importance calculation unit 12 calculates the importance of each piece of unlabeled data using a density of unlabeled data and the density of labeled data in the region where the piece of unlabeled data as a reference is arranged and has a predetermined size.

Specifically, as in the second example embodiment, each piece of unlabeled data is denoted by Dn. The density of labeled data in the region where the piece of unlabeled data Dn as a reference is arranged and has the predetermined size is denoted by ρ_{L}(Dn). Further, the density of unlabeled data in the region is denoted by ρ_{NL}(Dn) in the third example embodiment.

The importance calculation unit 12 obtains the densities ρ_{L}(Dn) and ρ_{NL}(Dn), then calculates the importance W(Dn) of each piece of unlabeled data Dn according to Formula (4).

W(Dn)=ρ_{NL}(Dn)/(ρ_{L}(Dn)+ρ_{NL}(Dn)) (4)

The importance W(Dn) by Formula (4) approaches “1” as the density of labeled data ρ_{L}(Dn) becomes smaller than the density of unlabeled data ρ_{NL}(Dn). In other words, the importance W(Dn) approaches “0” as the density of labeled data ρ_{L}(Dn) becomes higher than the density of unlabeled data ρ_{NL}(Dn).

A configuration of the dictionary learning device 10 according to the third example embodiment, except the configuration for the importance calculation described above, is the same as the configuration of the second example embodiment.

The dictionary learning device 10 according to the third example embodiment includes the function of selecting the unlabeled data that is in the region where has a high density of unlabeled data compared with the density of labeled data (i.e., the density of labeled data is low) and is close to the discrimination boundary. The dictionary learning device 10 according to the third example embodiment can efficiently and accurately learn the discrimination function (dictionary) as in the first and second example embodiments.

### Fourth Example Embodiment

A fourth example embodiment of the present invention will be described below. Note that in the description of the fourth example embodiment, components with the same names as the names of components constituting the dictionary learning devices according to the second and third example embodiment are given the same reference symbols and repeated description of the common components will be omitted.

In the fourth example embodiment, the K-nearest neighbor algorithm is used for calculating a density of data.

Here, a total number of pieces of labeled data is denoted by N_{L}. Further, a volume of a hypersphere that has a volume including a preset number K_{L} of pieces of labeled data and is based on unlabeled data Dn is denoted by V_{L}. In this case, a density of labeled data ρ_{L}(Dn) in the hypersphere is represented by Formula (5).

ρ_{L}(Dn)=K_{L}/(N_{L}×V_{L}) (5)

A total number of pieces of unlabeled data is denoted by N_{NL}. A volume of a hypersphere that has a volume including a preset number K_{NL} of pieces of unlabeled data and is based on the unlabeled data Dn is denoted by V_{NL}. In this case, a density of unlabeled data ρ_{NL}(Dn) in the hypersphere is represented by Formula (6).

ρ_{NL}(Dn)=K_{NL}/(N_{NL}×V_{NL}) (6)

Further, assuming that a piece of data that is farthest from unlabeled data Dn among K_{L} pieces of labeled data is denoted by data D_{L}, it can be considered that V_{L}=V_{NL} when the number of pieces of unlabeled data in the hypersphere that satisfy a radius |Dn−D_{L}| is K_{NL}. In this case, Formula (7) can be derived from Formula (5) and Formula (6).

ρ_{NL}(Dn)/ρ_{L}(Dn)=(K_{NL}×N_{L})/(K_{L}×N_{NL}) (7)

Further, Formula (8) can be derived using Formula (7) and Formula (4)

W(Dn)=(K_{NL}×N_{L})/((K_{L}×N_{NL})+(K_{NL}×N_{L})) (8)

Based on Formula (8), the importance calculation unit 12 in the fourth example embodiment calculates the importance W(Dn) of each piece of unlabeled data Dn.

A configuration of the dictionary learning device 10 according to the fourth example embodiment, except the configuration for the importance calculation described above, is the same as the configuration of the second or third example embodiment.

As in the first to three example embodiments, the dictionary learning device 10 according to the fourth example embodiment includes the function of selecting the unlabeled data that has the low density of labeled data and is close to the discrimination boundary. Thus, the dictionary learning device 10 according to the fourth example embodiment therefore can efficiently and accurately learn the discrimination function (dictionary).

### Other Example Embodiments

Note that the present invention is not limited to the first to forth example embodiments and can employ various example embodiments. For example, the selection unit 14 calculates the selection priority level J(Dn) according to Formula (3) in the second to fourth example embodiments. Instead of this, the selection unit 14 may calculate the selection priority level J(Dn) using a preset monotonically decreasing function f(r(Dn; θ)), for example. In this case, the selection unit 14 calculates the selection priority level J(Dn) according to Formula (9).

J(Dn)=W(Dn)⁷×f(r(Dn; θ)) (9)

Even when the selection unit 14 selects data using the selection priority levels J(Dn) according to Formula (9), the same advantageous effects as those of each of the second to fourth example embodiments can be achieved.

Further, the importance calculation unit 12 in the third example embodiment calculates the importance W(Dn) according to Formula (4) in which the importance W(Dn) becomes large when the density ρ_{NL}(Dn) of unlabeled data is high compared with the density ρ_{L}(Dn) of labeled data. Instead of this, the importance calculation unit 12 may calculate the importance W(Dn) that becomes large when the density ρ_{L}(Dn) of labeled data is lower compared with the density ρ_{NL}(Dn) of unlabeled data.

The present invention has been described above by taking the example embodiments described above as model examples. However, the present invention is not limited to the example embodiments described above. The present invention can employ various modes that can be understood by those skilled in the art within the scope of the present invention.

This application is based upon and claims the benefit of priority from Japanese Patent Application No. 2016-247431, filed on Dec. 21, 2016, the disclosure of which is incorporated herein in its entirety by reference.

### REFERENCE SIGNS LIST

1, 10 Dictionary learning device
2, 12 Importance calculation unit
3 Data selection unit
14 Selection unit
16 Labeling unit
17 Improvement unit

What is claimed is:

1. A dictionary learning device comprising:
a processor configured to:
calculate an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size; and
select data to be labeled from among the plurality of pieces of unlabeled data using information on closeness of the piece of unlabeled data to a discrimination boundary and information on the calculated importance, the discrimination boundary being based on a discrimination function to serve as a basis for discriminating data.

2. The dictionary learning device according to claim 1, wherein the processor calculates the importance of the piece of unlabeled data using a ratio between the density of labeled data and a density of unlabeled data in the region having the predetermined size and the piece of unlabeled data as the reference position.

3. The dictionary learning device according to claim 2, wherein the processor calculates the importance that increases as a ratio of the density of unlabeled data to the density of labeled data increases.

4. The dictionary learning device according to claim 2, wherein the processor calculates the importance that increases as a ratio of the density of labeled data to the density of unlabeled data decreases.

5. The dictionary learning device according to claim 1, wherein the processor is further configured to:
when information on a label with which the selected piece of unlabeled data is to be labeled is received from outside, give the selected piece of unlabeled data with the label using the received information; and
improve the discrimination function by learning a dictionary using a plurality of pieces of the training data, the plurality of pieces of the training data including new piece of labeled data given the label, the dictionary being a parameter of the discrimination function.

6. A dictionary learning method comprising:
by a processor,
calculating an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size;
selecting data to be labeled from among the plurality of pieces of unlabeled data using information on closeness of the piece of unlabeled data to a discrimination boundary and information on the calculated importance, the discrimination boundary being based on a discrimination function to serve as a basis for discriminating data;
when information on a label with which the selected piece of unlabeled data is to be labeled is received from outside, giving the selected piece of unlabeled data with the label; and
improving the discrimination function by learning a dictionary using a plurality of pieces of the training data, the plurality of pieces of the training data including new piece of labeled data given the label, the dictionary being a parameter of the discrimination function.

7. (canceled)

8. A non-transitory program storage medium on which a computer program is stored, the computer program causing a computer to perform:
calculating an importance of a piece of unlabeled data using a density of labeled data, the piece of unlabeled data being a piece of training data that is arranged in a feature space at a position based on a feature vector of the piece of training data, the feature space being a space having an element constituting the feature vector of the piece of training data as a variable, the density of labeled data being a density with respect to a piece of labeled data, the piece of labeled data being the piece of training data in the feature space, the density of labeled data being a density of pieces of labeled data in a region where the piece of unlabeled data as a reference is arranged and has a predetermined size;
selecting data to be labeled from among the plurality of pieces of unlabeled data using information on closeness of the piece of unlabeled data to a discrimination boundary and information on the calculated importance, the discrimination boundary being based on a discrimination function to serve as a basis for discriminating data.
